(19) United States
(12) Patent Application Publication
(10) Pub. No.: US 2010/0141147 A1
(43) Pub. Date: Jun. 10, 2010

(54) CAPACITIVELY COUPLED PLASMA (CCP) GENERATOR WITH TWO INPUT PORTS

(75) Inventors: CHIH-CHEN CHANG, Taipei County (TW); TUNG-CHUAN WU, Hsinchu City (TW); CHAN-HSING LO, Hsinchu County (TW); CHING-HUEI WU, Hsinchu City (TW); JEN-RONG HUANG, Hsinchu City (TW); MUH-WANG LIANG, Miaoli County (TW); CHIA-HAO CHANG, Hsinchu City (TW)

Correspondence Address: WPAT, PC;INTELLECTUAL PROPERTY ATTORNEYS, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/425,154

(22) Filed: Apr. 16, 2009

(30) Foreign Application Priority Data
Dec. 9, 2008 (TW) 097147755

(51) Int. Cl. H05H 1/24

(52) U.S. Cl. 315/111.21

(57) ABSTRACT

A capacitively coupled plasma (CCP) generator with two input ports, which is especially used as a large-area capacitively coupled plasma (CCP) generator. In the inventive CCP generator, only a RF power supply is required to provide the two input ports with RF power. The input impedance at each of the input ports is adjustable so that the standing wave between two rectangular electrodes can be eliminated to achieve plasma uniformity.

### BACKGROUND OF THE INVENTION

1. Field of the Invention

The present invention generally relates to a capacitively coupled plasma generator and, more particularly, to a large-area capacitively coupled plasma generator using an RF power supply to provide the two input ports with RF power. The input impedance at each of the input ports is adjustable so that the standing wave between two rectangular electrodes can be eliminated to achieve plasma uniformity.

2. Description of the Prior Art

With the increase in the size of glass substrates for thin-film solar cells, the size of the large-area plasma generator has to be larger. Therefore, it is crucial to eliminate standing wave in the large-area plasma generator.

The large-area plasma generator is widely used in plasma-enhanced chemical vapor-phase deposition (PECVD) for thin-film solar cells (especially thin-film solar cells on the glass substrate). Unlike the linear plasma generator wherein plasma extends in one dimension, the large-area plasma generator generates plasma that extends in two dimensions. The size of the currently available glass substrate exceeds 1 m² and, therefore, the size of the large-area plasma generator has to exceed 1 m². On the other hand, the plasma generator for depositing Si thin films is mostly realized by the capacitively coupled plasma generator operating in the VHF band (40˜80 MHz). Two reasons for generating plasma in the VHF band are: 1. The capacitively coupled plasma generator operating in the VHF band generates plasma with higher plasma density than the conventional plasma generator operating in the HF band (13.56 MHz); and 2. Lower plasma sheath potential. High plasma density results in higher deposition rate, while lower plasma sheath potential leads to reduced ion bombardment onto the thin film to improve the film quality. However, the higher operating frequency often causes significant standing wave. Especially when the size of the capacitively coupled plasma generator is larger than m² and the operating frequency increases from the HF band to the VHF band, the effect due to standing wave becomes significant to worsen the plasma uniformity, and hence the thickness uniformity of the thin film.

Since the currently available glass substrates for thin-film solar cells are rectangular or square, the capacitively coupled plasma generator uses rectangular or square electrodes. However, the standing wave is inevitable. The electric field distribution of the capacitively coupled plasma generator with the electrodes having the size of 1 m² can be analyzed with Maxwell Equations by a high-frequency structure simulator. It is noted that higher frequency leads to more significant standing wave.

To eliminate standing wave in the capacitively coupled plasma generator with rectangular electrodes, U.S. Pat. No. 7,141,516 discloses an RF plasma generator, as shown in FIG. 1. In FIG. 1, the RF plasma generator 1 comprises a plasma chamber 10, two input ports 11 and 12, two impedance matching circuits 13 and 14, two RF power supplies 15 and 16, a phase modulator 17 and two resonators 18 and 19. Accordingly, an adjustable phase difference appears between the two ports to change the position where standing wave takes place. In a viewpoint of a long period of time, the electric field is uniform. Therefore, with calculation by the high-frequency structure simulator, it can be understood that the nodes of standing wave are vibrating with the change of phase difference.

Therefore, there is need in providing a capacitively coupled plasma generator using an RF power supply to provide the two input ports with RF power. The input impedance at each of the input ports is adjustable so that the standing wave between two rectangular electrodes can be eliminated to achieve plasma uniformity.

### SUMMARY OF THE INVENTION

The present invention provides a capacitively coupled plasma generator using an RF power supply to provide the two input ports with RF power. The input impedance at each of the input ports is adjustable so that the standing wave between two rectangular electrodes can be eliminated to achieve plasma uniformity.

The present invention further provides a capacitively coupled plasma generator using an RF power supply to provide the two input ports with RF power. The phase difference at each of the input ports is adjustable so that the standing wave between two rectangular electrodes can be eliminated to achieve plasma uniformity.

In one embodiment, the present invention provides a capacitively coupled plasma generator, comprising: a first input port, being coupled to a rectangular electrode; a first input port, being coupled to a rectangular electrode; a second input port, being coupled to the rectangular electrode; a first impedance modulator, being coupled to the first input port; a second impedance modulator, being coupled to the second input port; an impedance matching circuit, being coupled to the first impedance modulator and the second impedance modulator, respectively; and an RF power supply, being coupled to the impedance matching circuit.

In another embodiment, the present invention further provides a capacitively coupled plasma generator, comprising: a first input port, being coupled to a rectangular electrode; a second input port, being coupled to the rectangular electrode; a phase delay device, being coupled to the first input port; an impedance matching circuit, being coupled to the phase delay device and the second input port, respectively; and an RF power supply, being coupled to the impedance matching circuit.

In another embodiment, the present invention further provides a capacitively coupled plasma generator, comprising: a first input port, being coupled to a rectangular electrode; a second input port, being coupled to the rectangular electrode; a pair of transmission lines with phase delay, being coupled to the first input port and the second input port, respectively; an impedance matching circuit, being coupled to the pair of transmission lines with phase delay, respectively; and an RF power supply, being coupled to the impedance matching circuit.

### BRIEF DESCRIPTION OF THE DRAWINGS

The objects, spirits and advantages of various embodiments of the present invention will be readily understood by the accompanying drawings and detailed descriptions, wherein:

FIG. 1 is a schematic diagram of a conventional RF plasma generator schematic diagram;

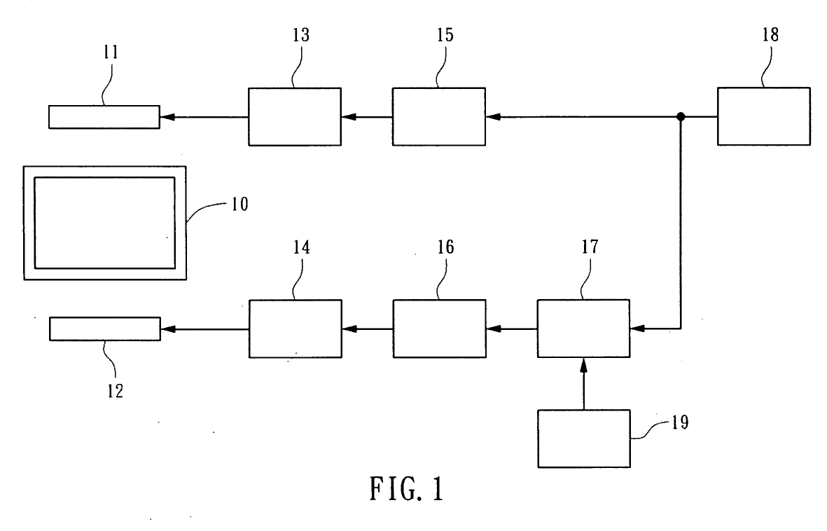

FIG. 2 is a schematic diagram of an RF plasma generator according to one embodiment of the present invention; and

FIG. 3 is a schematic diagram of an RF plasma generator according to another embodiment of the present invention.

### DETAILED DESCRIPTION OF THE PREFERRED EMBODIMENT

The present invention can be exemplified but not limited by the embodiments as described hereinafter.

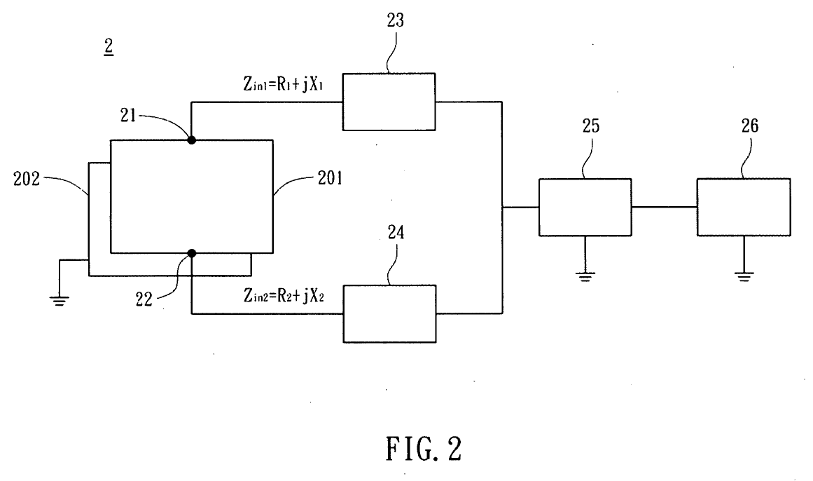

Please refer to FIG. 2, which is a schematic diagram of an RF plasma generator according to one embodiment of the present invention. In FIG. 2, the capacitively coupled plasma generator 2 comprises: a first input port 21, a second input port 22, a first impedance modulator 23, a second impedance modulator 24, an impedance matching circuit 25 and an RF power supply 26. More particularly, the first input port 21 and the second input port 22 are respectively coupled to a rectangular electrode 201. The rectangular electrode 201 is disposed in parallel with another rectangular electrode 202 that is grounding so as to construct a plasma chamber (not shown). The first impedance modulator 23 and the second impedance modulator 24 are respectively coupled to the first input port 21 and the second input port 22 so as to modulate the input impedance of the first input port 21 and the second input port 22. Moreover, the impedance matching circuit 25 transmits the RF power generated by the RF power supply 26 to the first impedance modulator 23 and second impedance modulator 24 to prevent signal reflection at high frequencies due to impedance mismatch.

In the present embodiment, the first impedance modulator 23 comprises an inductor and a variable resistor. The input impedance of the first input port 21 is determined by selecting and adjusting the values of the passive elements. Preferably, the second impedance modulator 24 comprises a variable resistor. The input impedance of the second input port 22 is determined by selecting and adjusting the values of the passive elements. For example, the input impedance of the first input port 21 is R₁+jX₁, while the input impedance of the second input port 22 is R₂+jX₂. In the present embodiment, only an RF power supply is used to provide the two input ports with RF power. The input impedance at each of the input ports is adjustable so that the standing wave between two rectangular electrodes can be eliminated to achieve plasma uniformity.

Moreover, the first input port 21 and the second input port 22 are respectively disposed on two opposite sides of the rectangular electrode 201 and are symmetric to each other with respect to a central line to achieve plasma uniformity.

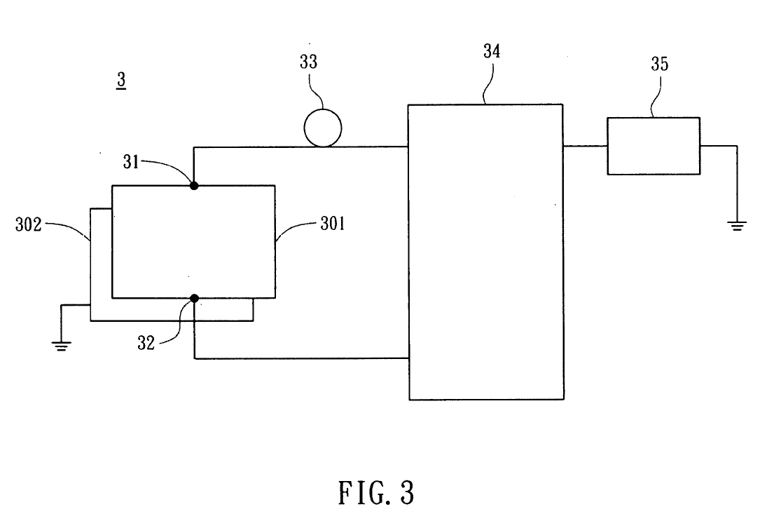

Please refer to FIG. 3, which is a schematic diagram of an RF plasma generator according to another embodiment of the present invention. In FIG. 3, the capacitively coupled plasma generator 3 comprises: a first input port 31, a second input port 32, a phase delay device 33, an impedance matching circuit 34 and an RF power supply 35. More particularly, the first input port 31 and the second input port 32 are respectively coupled to a rectangular electrode 301. The rectangular electrode 301 is disposed in parallel with another rectangular electrode 302 that is grounding to construct a plasma chamber (not shown). The phase delay device 33 is coupled to the first input port 31 so that a phase difference appears between the first input port 31 and the second input port 32. Moreover, the impedance matching circuit 34 transmits the RF power generated by the RF power supply 35 to the phase delay device 33 and the second input port 32 to prevent signal reflection at high frequencies due to impedance mismatch.

In the present embodiment, the phase delay device 33 is a transmission line with phase delay. In the present embodiment, only an RF power supply is used to provide the two input ports with RF power. The phase difference at each of the input ports is adjustable so that the standing wave between two rectangular electrodes can be eliminated to achieve plasma uniformity.

Moreover, the first input port 31 and the second input port 32 are respectively disposed on two opposite sides of the rectangular electrode 301 and are symmetric to each other with respect to a central line to achieve plasma uniformity.

In addition to the above two embodiments, anyone with ordinary skill in the art can make modifications without departing from the spirit and scope of the present invention. For example, to achieve the phase difference between the two input ports 31 and 32 in FIG. 3, the phase delay device 33 between the two input ports 31 and 32 and the impedance matching circuit 34 in FIG. 3 can be replaced by a pair of transmission lines with phase delay. In this manner, standing wave between the rectangular electrodes can also be eliminated to achieve plasma uniformity.

Accordingly, the present invention discloses a capacitively coupled plasma generator using an RF power supply to provide the two input ports with RF power. The input impedance at each of the input ports is adjustable so that the standing wave between two rectangular electrodes can be eliminated to achieve plasma uniformity. Therefore, the present invention is useful, novel and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A capacitively coupled plasma generator, comprising:
a first input port, being coupled to a rectangular electrode;
a first input port, being coupled to a rectangular electrode;
a second input port, being coupled to the rectangular electrode;
a first impedance modulator, being coupled to the first input port;
a second impedance modulator, being coupled to the second input port;
an impedance matching circuit, being coupled to the first impedance modulator and the second impedance modulator, respectively; and
an RF power supply, being coupled to the impedance matching circuit.

2. The capacitively coupled plasma generator as recited in claim 1, wherein the first impedance modulator comprises an inductor and a variable resistor.

3. The capacitively coupled plasma generator as recited in claim 1, wherein the second impedance modulator comprises a variable resistor.

4. The capacitively coupled plasma generator as recited in claim 1, wherein the first input port and the second input port are respectively disposed on two opposite sides of the rectangular electrode and are symmetric to each other with respect to a central line.

5. The capacitively coupled plasma generator as recited in claim 1, wherein the input impedance of the first input port is R₁+jX₁.

6. The capacitively coupled plasma generator as recited in claim 1, wherein the input impedance of the second input port is R₂+jX₂.

7. A capacitively coupled plasma generator, comprising:
a first input port, being coupled to a rectangular electrode;
a second input port, being coupled to the rectangular electrode;
a phase delay device, being coupled to the first input port;
an impedance matching circuit, being coupled to the phase delay device and the second input port, respectively; and
an RF power supply, being coupled to the impedance matching circuit.

8. The capacitively coupled plasma generator as recited in claim 7, wherein the first input port and the second input port are respectively disposed on two opposite sides of the rectangular electrode and are symmetric to each other with respect to a central line.

9. The capacitively coupled plasma generator as recited in claim 7, wherein the phase delay device is a transmission line with phase delay.

10. A capacitively coupled plasma generator, comprising:
a first input port, being coupled to a rectangular electrode;
a second input port, being coupled to the rectangular electrode;
a pair of transmission lines with phase delay, being coupled to the first input port and the second input port, respectively;
an impedance matching circuit, being coupled to the pair of transmission lines with phase delay, respectively; and
an RF power supply, being coupled to the impedance matching circuit.

11. The capacitively coupled plasma generator as recited in claim 10, wherein the first input port and the second input port are respectively disposed on two opposite sides of the rectangular electrode and are symmetric to each other with respect to a central line.
